(19) United States
(12) Patent Application Publication
(10) Pub. No.: US 2026/0052400 A1
(43) Pub. Date: Feb. 19, 2026

(54) SYSTEMS AND METHODS FOR MIXING AND MATCHING MULTI-VENDOR BASEBAND UNITS AND RADIO UNITS IN OPEN RADIO ACCESS NETWORKS

(71) Applicant: AT&T Intellectual Property I, L.P., Atlanta, GA (US)

(72) Inventors: Ye Chen, Marietta, GA (US); Hongyan Lei, Plano, TX (US); Zhi Cui, Sugar Hill, GA (US)

(73) Assignee: AT&T Intellectual Property I, L.P., Atlanta, GA (US)

(21) Appl. No.: 18/806,235

(22) Filed: Aug. 15, 2024

(51) Int. Cl. H04W 16/18; H04W 24/02

(52) U.S. Cl. CPC H04W 16/18; H04W 24/02

(57) ABSTRACT

Aspects of the subject disclosure may include, for example, maintaining performance data relating to performance of a plurality of different combinations between a plurality of radio units (RUs) and a plurality of baseband units (BBUs), where the plurality of RUs and the plurality of BBUs are connected via an open fronthaul interface of Open Radio Access Network (ORAN), determining service and performance requirements of a user equipment (UE), and based on the performance data and the determined service and performance requirements of the UE, generating a target combination by selecting a RU among the plurality of RUs and selecting a BBU among the plurality of BBUs such that the target combination meets the determined service and performance requirements. Other embodiments are disclosed.

### FIELD OF THE DISCLOSURE

The subject disclosure relates to systems and methods for mixing and matching multi-vendor baseband units and radio units in open radio access networks.

### BACKGROUND

Most of Radio Access Network (RAN) systems for major vendors run and are maintained as a closed system. Network operators typically select one RAN vendor to deploy both baseband units and radio units. There may be no mix and match of RAN systems offered by different RAN vendors for a given site. The Open RAN (ORAN) standard and eco-system are moving towards supporting an open fronthaul to allow mix and match of different RAN vendors' baseband units with other vendor's radio units, thereby stimulating more diverse eco-system and spurring the innovation.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A illustrates an exemplary base station in the related art.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of O-RAN architecture functioning within the communication network of FIG. 1 and supporting FIGS. 2B and 2D in accordance with various aspects described herein.

FIG. 2D is a block diagram illustrating another example, non-limiting embodiment of a system functioning within the communication network of FIG. 1 in accordance with various aspects described herein.

FIG. 2E depicts an illustrative embodiment of a method in accordance with various aspects described herein.

FIG. 2F depicts an illustrative embodiment of another method in accordance with various aspects described herein.

FIG. 2G depicts an illustrative embodiment of yet another method in accordance with various aspects described herein.

FIG. 2H depicts an illustrative embodiment of further yet another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for mixing and matching multi-vendor baseband units and radio units in open radio access (ORAN) networks. The systems and methods facilitate an adaptive selection, such as different mix and match or combinations of the baseband units and radio units by different radio access network (RAN) providers or vendors in light of various network parameters and performance and service requirements by users or subscribers. The systems and methods operate in the ORAN networks which support and facilitate an open fronthaul interface between the baseband units and the radio units. Other embodiments are described in the subject disclosure.

One or more aspects of the subject disclosure are directed to a device including a processing system including a processor and a memory that stores executable instructions that, when executed by the processing system, facilitate performance of operations. The operations include storing a first set of data relating to a pool of radio units (RUs) offered by a first group of different vendors; storing a second set of data relating to a pool of baseband units (BBUs) offered by a second group of different vendors, where the RUs and the BBUs are connected via an open fronthaul interface of Open Radio Access Network (ORAN); maintaining a third set of data relating to performance of a plurality of different combinations between each RU in the pool of RUs and each BBU in the pool of BBUs; and at least based on the third set of data, selecting a RU among the pool of RUs and a BBU among the pool of BBUs and generating a target combination.

One or more aspects of the subject disclosure are directed to a non-transitory machine-readable medium, comprising executable instructions that, when executed by a processing system including a processor, facilitate performance of operations. The operations include maintaining performance data relating to performance of a plurality of different combinations between a plurality of radio units (RUs) and a plurality of baseband units (BBUs), wherein the plurality of RUs and the plurality of BBUs are connected via an open fronthaul interface of Open Radio Access Network (ORAN); determining service and performance requirements of a user equipment (UE); and based on the performance data and the determined service and performance requirements of the UE, generating a target combination by selecting a RU among the plurality of RUs and selecting a BBU among the plurality of BBUs, wherein the target combination meets the determined service and performance requirements.

One or more aspects of the subject disclosure are directed to a method including maintaining, by a processing system including a processor, performance data relating to performance of a plurality of different combinations including a radio unit (RU) and a baseband unit (BBU), where the RU and the BBU are connected via an open fronthaul interface of Open Radio Access Network (ORAN); determining, by the processing system, service and performance requirements of a user equipment (UE); and based on the performance data and the determined service and performance requirements of the UE, generating, by the processing system, a target combination by mixing and matching the RU and the BBU such that the target combination facilitates the determined service and performance requirements.

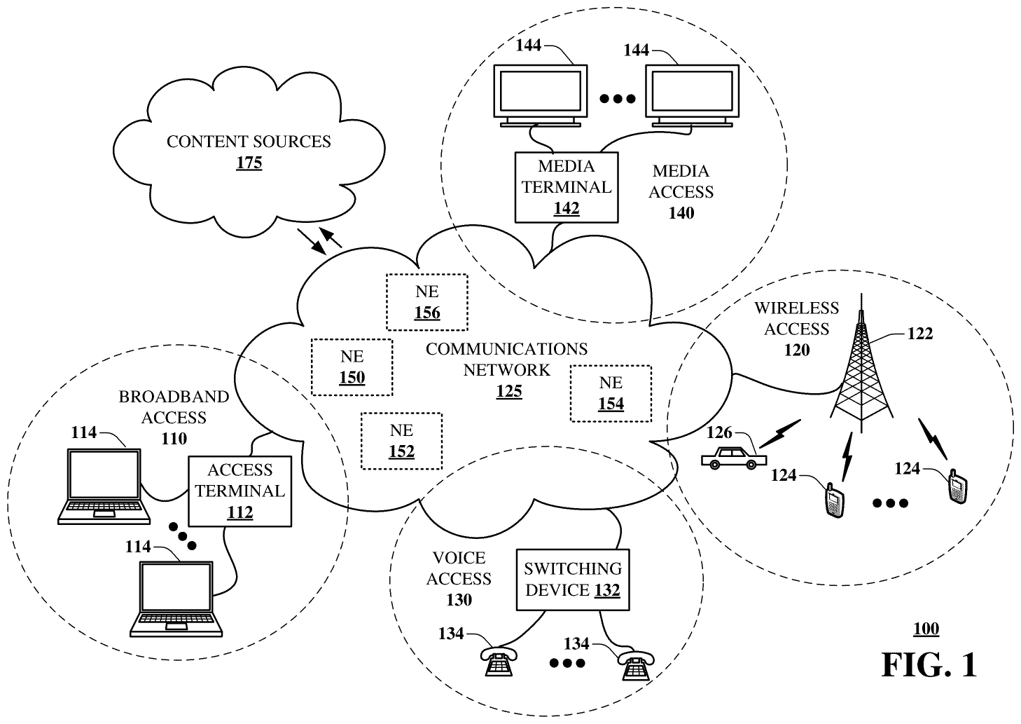

Referring now to FIG. 1, a block diagram is shown illustrating an example, non-limiting embodiment of a system 100 in accordance with various aspects described herein. For example, system 100 can facilitate in whole or in part systems and methods for mixing and matching multi-vendor baseband units and radio units in open radio access (ORAN) networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

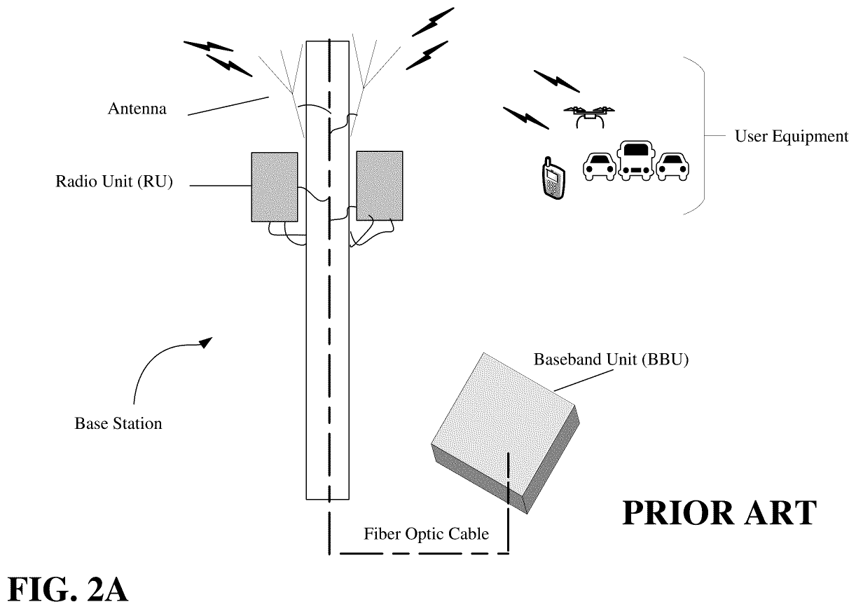

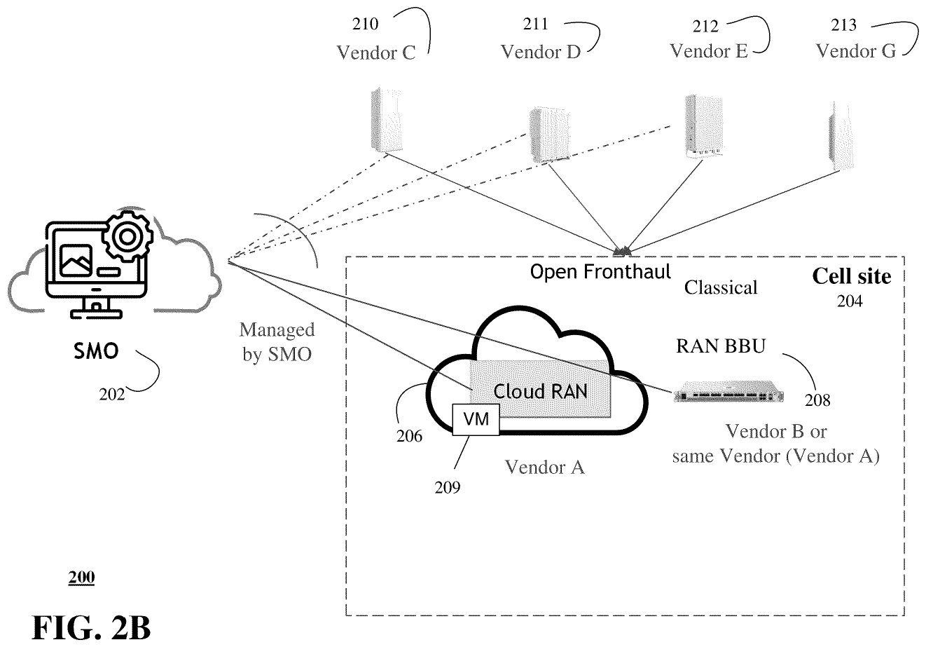

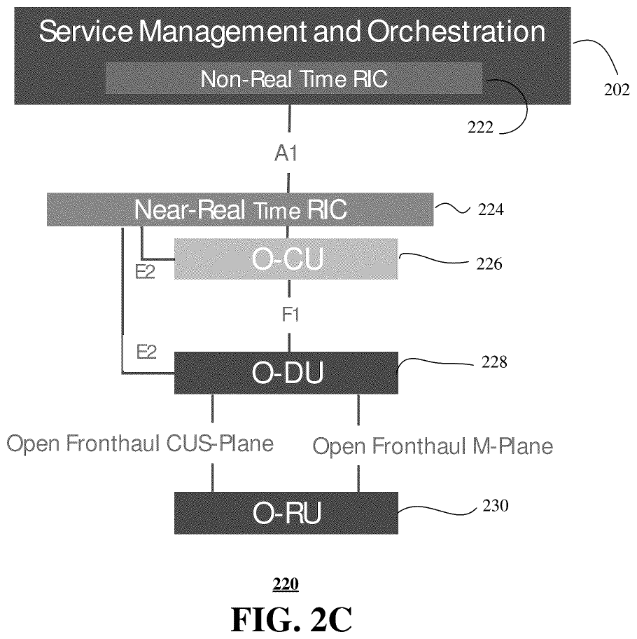

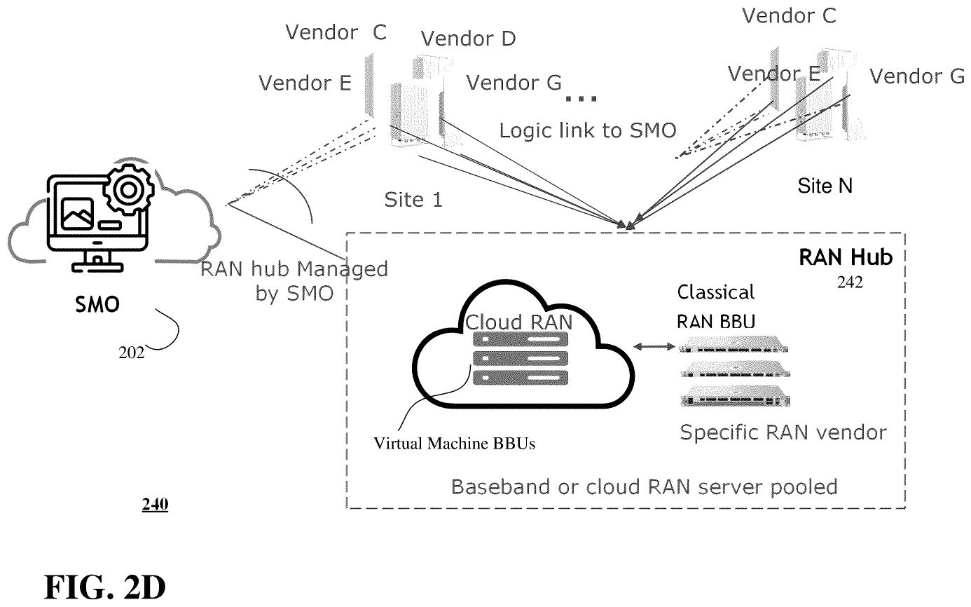

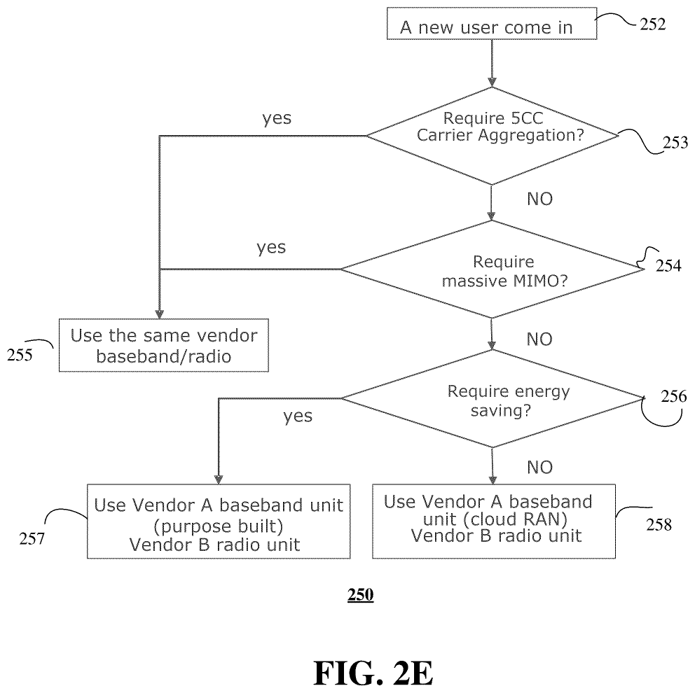

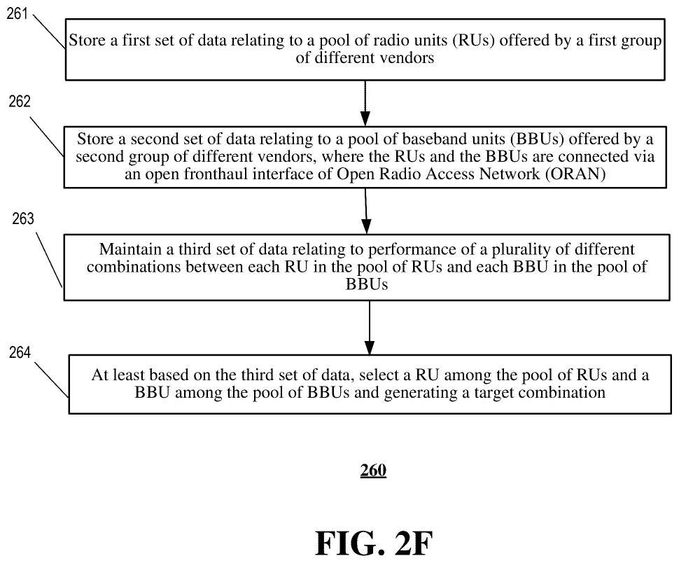

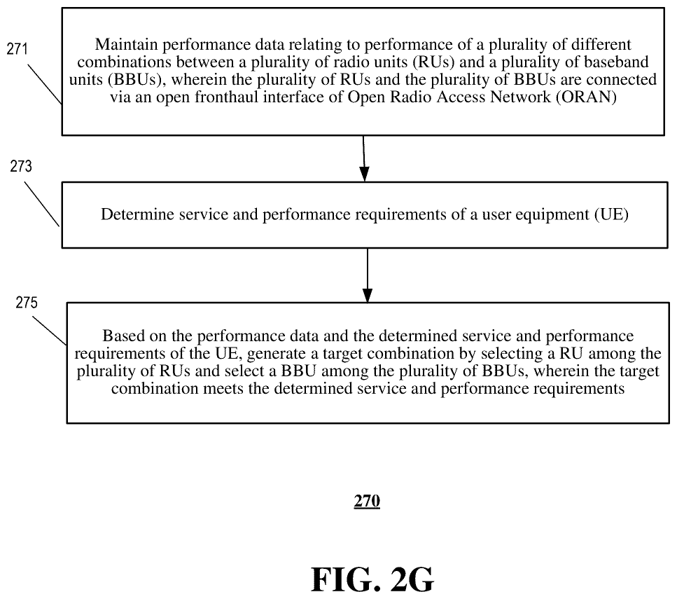

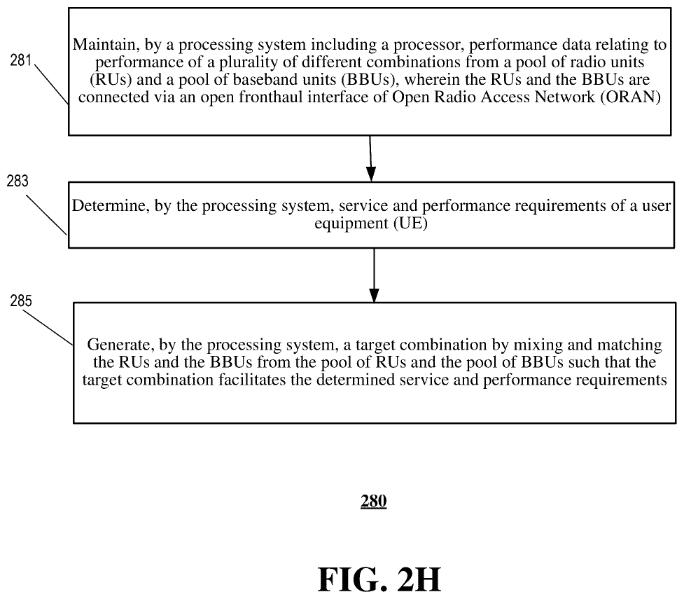

FIG. 2A illustrates an exemplary base station according to the related art. The base station includes antennas, a radio unit (RU), and a baseband unit (BBU) that are connected via fiber optic cables. The antenna interfaces with user equipment wirelessly and transmits and receives radio frequency (RF) signals, as depicted in FIG. 2A. The radio unit (RU) converts the RF signals into data signals or converts data signals to the RF signals and filters and amplifies the RF signals. The BBU manages the base station including operation maintenance and signal processing.

Deployment of an O-RAN compliant RAN system may facilitate mixing and matching BBUs and RUs offered by different RAN vendors. Different combination of the RAN BBU and RU from different vendors may have different performance, features/functions support, compatibility, different energy consumption, etc. Currently, mix-and-match deployment of the BBUs and the RUs may be limited to static and fixed configurations, which may be sub-optimal to serve different types of devices and services involving different user equipment and different network conditions. An adaptive solution for mixing and matching different BBUs and RUs offered by different RAN vendors, in light of ever changing network conditions and performance and service requirements from various user equipment, can potentially optimize the RAN performance.

The subject disclosure is directed to adaptive systems and methods for mixing and matching multi-vendor baseband units and radio units in open radio access networks. The adaptive multi-vendor RAN and radio selection systems and methods can be used for a distributed RAN deployment or a centralized RAN deployment, as will be described in detail below. The adaptive systems and methods can be implemented either with a local coordination at a RAN compute or via a centralized management system such as service management and orchestration (SMO) in the ORAN. Selection of different BBUs and RUs is adaptively and dynamically made based on the performance/function differences and energy savings among different combinations of BBUs/RUs in light of service requirements, different user equipment, and/or network conditions in order to find the best match to the subscriber/user service performance and function requirements.

FIG. 2B is a block diagram illustrating an example, non-limiting embodiment of a system 200 functioning within the communication network of FIG. 1 in accordance with various aspects described herein. The system 200 operates as an adaptive multi-vendor RAN and RU selection system which implements a distributed RAN deployment. The distributed RAN deployment indicates that RUs may be placed or arranged at distributed locations rather than at a cell site 204. As will be set forth below, FIG. 2D illustrates an example, non-limiting embodiment of a centralized RAN deployment. As depicted in FIG. 2B, the BBU is arranged at the cell site 204, whereas RUs may not be arranged at the cell site 204. RUs may not be placed at the same location as BBU at cell site as long as a latency between RUs and the BBU is less than fronthaul latency requirements (for example, one-way latency is 75 micro-second, which will be translated to a distance based on the speed of light for the fiber link). In various embodiments, RUs are offered and provided by different vendors such as Vendor C 210, Vendor D 211, Vendor E 212, Vendor G, etc. At the cell site 204, the BBU is arranged as a classical RAN BBU 208, or alternatively, a virtual machine (VM) 209 running in a cloud RAN.

As depicted in FIG. 2B, the classical RAN BBU 208 is provided by Vendor B, whereas the VM 209 in the cloud RAN 206 is provided by Vendor A. The cloud RAN relates to virtualization of RAN. While virtualization of the RAN is not the same as the ORAN, the virtualization of the RAN can be deployed in conjunction with the ORAN and makes the RAN much more flexible. For instance, a distributed unit (DU) and a control unit (CU) may be effectively computers running software. Instead of using custom hardware, the DU and the CU can now be virtualized and run on a cloud server, as long as physical transmission conditions are met. A cloud computing hardware platform and software are available and provided by various vendors. A mobile vendor can also use alternative cloud computing hardware from a different vendor and run another vendor's RAN software on the cloud computing hardware. Referring back to FIG. 2B, Vendor A provides a cloud computing hardware platform and software, or provides the cloud computing hardware platform only or software only.

Additionally, or alternatively, the BBU, as either the classical BBU 208 or the virtual machine 209, can be provided by the same vendor.

In various embodiments, the system 200 includes a service management and orchestration (SMO) platform 202 to manage the BBU arranged at the cell site 204 and the RUs available and offered by different vendors 210, 211, 212 and 213. The SMO platform 202 has actual physical connectivity via the RAN BBU 208 or 209. With respect to the RUs, the SMO platform 202 has logical management connectivity for the RUs. The SMO platform 202 stores, maintains, and/or accesses a set of data relating to the RAN BBU and the RUs. The SMO platform 202 further stores, maintains and/or accesses another set of data (e.g., performance data) relating to performance of different combinations of the RAN BBU and the RUs. Additionally, the SMO platform 202 further accesses users and/or subscriber services and performance requirements. For instance, services and performance requirements include energy savings, Multiple Input Multiple Output (MIMO) requirements, low latency requirements, carrier aggregation requirements, etc. Based on the users/subscriber services and performance requirements, the SMO platform 202 can select an optimal combination of the RAN BBU and RUs which are available and offered by multiple vendors and/or in different forms (e.g., the virtual machine in the cloud RAN v. the classical RAN BBU).

In various embodiments, instead of using the SMO platform 202, selecting an optimal combination of the RAN BBU and the RU(s) can be done locally at the cell site 204. The RAN BBU 208 or the virtual machine 209 can determine the optimal combination of the RAN BBU and the RU(s).

The system 200 includes an open fronthaul interfacing the cell site 204 and the RUs offered by different vendors. The ORAN supports the open fronthaul interface to disaggregate and virtualize the RAN protocol stack and divide capabilities between a physical cell site and virtual cell site functions. FIG. 2C is a block diagram illustrating an example, non-limiting embodiment of ORAN architecture 220 functioning within the communication network of FIG. 1 and supporting FIGS. 2B and 2D in accordance with various aspects described herein. Referring to FIG. 2C, the ORAN architecture 220 and various aspects supporting the embodiments of the present disclosure are described.

The ORAN architecture 220 includes the service management and orchestration platform 202 where a non-real time RAN intelligent controller (non-RT RIC) 222 is run. The non-RT RIC 222 is in communication with a near-real time RIC (near-RT RIC) 224 via an A1 interface. The near-RT RIC 224 is in communication with a control unit (O-CU) 226 and a distributed unit (O-DU) 228 via an E2 interface. The O-CU 226 is in communication with the O-DU 228 via an F1 interface. An Open Fronthaul Control User Synchronization (CUS) plane (CUS-plane) and an Open Fronthaul Management plane (M-plane) support interfaces between the O-DU 228 and a radio unit (O-RU) 230.

Under the ORAN architecture 220, capabilities between a physical cell site and virtual RAN functions are divided. The physical (PHY) block of a traditional cell site is split into low capabilities and high capabilities, where PHY-low capabilities reside on the RU and the PHY-high capabilities are installed on a virtual DU. The O-RU 230 contains radio frequency (RF) and PHY-low capabilities and resides at a cell site. The O-RU 230 also provides beamforming and analog/digital conversion. The O-RU 230 and the O-DU 228 are configured as a fronthaul segment of the ORAN. The O-DU 228 may be software that provides PHY-high capabilities. The O-DU 228 provides Radio Link Control (RLC) and Media Access Control (MAC) protocols. The O-DU 228 can reside on a server in an edge data center, a central office, or cloud. The O-DU 228 and the O-CU 226 are configured as a midhaul segment of the ORAN.

The O-CU 226 may be configured as software that provides processing for Packet Data Convergence (PDCP), Service Data Adaptation (SDAP), and Radio Resource Control (RRC). The O-CU 226 resides on a server in an edge data center, central office, or the cloud, and can be co-located with the O-DU 228. The O-CU 226 is connected to the mobile network core, such as 5G core, which is configured as a backhaul segment of the ORAN.

The O-RAN architecture 220 is open as ORAN compliant components are operating under open interfaces and use ORAN-defined standard application programming interfaces. It is more efficient and beneficial to use open standards in implementing the open interfaces. The open interfaces are available and required for different RAN vendors to integrate their systems and software with the ORAN architecture 220.

As descried above, the functional split of the PHY-low and PHY-high blocks between the O-RU 230 and O-DU 228, in some configurations, allows the O-DU 228 to control the O-RU 230. ORAN fronthaul protocols may allow one O-DU to control several O-RUs in the same cell but owned by multiple carriers.

The ORAN Open Fronthaul includes (1) Control Plane (CP) used to issue commands for scheduling, beam forming, and coordinating data transfers; (2) User Plane (UP) transferring I/Q data between O-DU 228 and O-RU 230 within strict time constraints and sitting on the O-CU 226 and connected to the O-DU via the F1 interface; and (3) Synchronization plane handling time, frequency, and synchronization between the O-DU 228 and O-RU 230. The ORAN Fronthaul further includes Management plane (the M-plane) installed on the O-RU 230 and the O-DU 229. The M-plane connects the base station to the Service Management and Orchestration (SMO) framework, which manages the O-RUs and O-DUs hierarchically or in a hybrid mode.

Referring back to FIG. 2B, by utilizing the ORAN architecture 220 and the open fronthaul interface, the SMO platform 202 manages and controls the RUs offered by different vendors 210, 211, 212 and 23 and the BBU 208 or the BBU virtual machine 209 (e.g., considered as O-DUs in FIG. 2C) offered by multi-vendors. The SMO platform 202 stores, maintains, and/or accesses performance data of the RUs and the BBU 208, 209 available and offered by multi-vendors and performance of various combinations of the RUs and the BBU 208, 209 at every cell site.

FIG. 2D is a block diagram illustrating another example, non-limiting embodiment of a system 240 functioning within the communication network of FIG. 1 in accordance with various aspects described herein. In various embodiments, the system 240 can be used for RAN BBUs placed at a centralized hub 242 with pooling.

In various embodiments, the system 240 operates as an adaptive multi-vendor RAN and RU selection system implementing the centralized RAN deployment. The centralized RAN deployment indicates that the RUs may be placed or arranged at a centralized location, such as a cell site. As depicted in FIG. 2D, the RUs offered by different vendors are arranged at each cell site, such as Site 1, Site 2, . . . . Site N. At the cell site, Site 1, RUs offered by Vendors C, D, E and G are pooled and arranged. At another cell site, Site n, RUs offered by Vendors C, E and G are pooled and arranged.

In various embodiments, the RAN BBUs are pooled and arranged at the RAN hub 242. The BBUs offered by different vendors are pooled and arranged at the RAN hub 242. As described above in connection with FIG. 2B, the BBUs can be implemented as a classical RAN BBU or in form of a virtual machine in a cloud RAN where different vendors' BBUs are pooled in the cloud RAN.

In various embodiments, the system 240 includes the SMO platform 202 to manage the BBUs arranged at the RAN hub 242 and the RUs available and offered by different Vendors at different cell sites. The processing system arranged in the SMO platform of the ORAN is communicatively connected to the plurality of RUs via the plurality of BBUs. In other words, the SMO platform 202 has actual physical connectivity via the RAN BBU 208 or 209. The SMO platform 202 has logical management connectivity for the RUs via the BBUs. The SMO platform 202 stores, maintains, and/or accesses a set of data relating to the RAN BBU and the RUs. The SMO platform 202 further stores, maintains and/or accesses another set of data (e.g., performance data) relating to performance of different combinations of the RAN BBU and the RUs. Additionally, the SMO platform 202 further accesses users and/or subscriber services and performance requirements. For instance, services and performance requirements include energy savings, Multiple Input Multiple Output (MIMO) requirements, low latency requirements, carrier aggregation requirements, etc. Based on the users/subscriber services and performance requirements, the SMO platform 202 can select an optimal combination of the RAN BBU and RUs which are available and offered by multiple vendors and/or in different forms (e.g., the virtual machine in the cloud RAN v. the classical RAN BBU).

In various embodiments, the selection of the different RAN BBUs (e.g., a purposed built BBU or a virtual machine in the cloud RAN) and RUs are based on various parameters, for example, including performance of a combination of a BBU and RU(s), Key features/functions support among different combinations, service and performance requirements from different devices and customers, available coverage among different combinations for a given user/customers, overall energy consumption and energy savings, etc. Additionally, or alternatively, the selection of the RAN BBUs and RUs may result in a selection of the RAN BBU and RU offered by a same vendor.

FIG. 2E depicts an illustrative embodiment of a method 250 in accordance with various aspects described herein. In various embodiments, the method 250 is directed to a non-limiting embodiment of selecting a combination of a BBU and RU(s) by different or same vendors. The selection of different BBUs and RUs are based on and in light of consideration of multiple factors/parameters. As depicted in FIG. 2E, a new user device is connected to the ORAN and requires a RAN connection (Step 252). It is determined whether the new user device requires 5GG Carrier Aggregation (5CC CA) (Step 253). 5CC CA is a technique that combines multiple carriers to increase data rates and bandwidth for user equipment in mobile networks. If the new user device does not require 5CC CA, then it is checked whether the new user device requires a massive MIMO (Step 254). If the new user device requires both 5CC CA and the massive MIMO, then a decision is made to use the same vendor BBU and RU (Step 255). The same vendor BBU and RU combination may support advanced features (e.g. 5CC CA and massive MIMO) and potentially offer the best performance.

If the requirements of the new user device do not include energy savings, in addition to requiring no 5CC CA and massive MIMO (Step 256), different vendors' BBU and RU can be mixed and matched (Step 258). More specifically, when no energy savings are required, then a BBU running in a cloud RAN can be used as opposed to a purpose built BBU (Step 258). If energy savings are required, then a purpose built or customized BBU and a RU offered by different vendors are used (Step 257).

FIG. 2F depicts an illustrative embodiment of a method 260 in accordance with various aspects described herein. The method 260 includes storing a first set of data relating to a pool of radio units (RUs) offered by a first group of different vendors (Step 261), storing a second set of data relating to a pool of baseband units (BBUs) offered by a second group of different vendors, where the RUs and the BBUs are connected via an open fronthaul interface of the ORAN (Step 262), maintaining a third set of data relating to performance of a plurality of different combinations between each RU in the pool of RUs and each BBU in the pool of BBUs (Step 263), and at least based on the third set of data, selecting a RU among the pool of RUs and a BBU among the pool of BBUs and generating a target combination (Step 264). Additionally, the method 260 further comprise determining service and performance requirements of a user equipment (UE). The generating the target combination further comprises, based on the determined service and performance requirements of the UE, generating the target combination that meets the determined service and performance requirements of the UE.

In various embodiments, one or more BBUs among the pool of BBUs are arranged at a respective cell site. Alternatively, a part of BBUs or all BBUs in the pool of BBUs are arranged at a RAN hub. Additionally or alternatively, the pool of BBUs are arranged at a cloud RAN as one or more virtual machines. Alternatively, one or more BBUs among the pool of BBUs may be purpose built or customized hardware.

In various embodiments, the selecting the RU among the pool of RUs and the BBU among the pool of BBUs further comprises selecting the RU and the BBU based on multiple parameters. The multiple parameters comprise performance of the target combination, a compatibility between the selected RU and BBU, an available coverage of the target combination, overall energy consumption and energy savings, or a combination thereof.

FIG. 2G depicts an illustrative embodiment of a method 270 in accordance with various aspects described herein. The method 270 includes maintaining performance data relating to performance of a plurality of different combinations between a plurality of radio units (RUS) and a plurality of baseband units (BBUs), where the plurality of RUs and the plurality of BBUs are connected via an open fronthaul interface of the ORAN (Step 271), determining service and performance requirements of a user equipment (UE) (Step 273), and based on the performance data and the determined service and performance requirements of the UE, generating a target combination by selecting a RU among the plurality of RUs and selecting a BBU among the plurality of BBUs such that the target combination meets the determined service and performance requirements (Step 275).

In various embodiments, the method 270 further includes determining to use the target combination offered by a same vendor, by selecting the RU and the BBU offered by the same vendor, in light of the determined service and performance requirements of the UE. Additionally, or alternatively, the generating the target combination further comprise generating the target combination by selecting the RU and the BBU offered by different vendors. The step of maintaining performance data further comprises maintaining the performance data by the processing system arranged in a service maintenance and orchestration (SMO) platform of the ORAN. The step of generating the target combination further comprises generating the target combination with the processing system arranged in the SMO platform. The method 270 further comprise storing a first set of data relating to the plurality of RUs offered by a first group of different vendors and storing a second set of data relating to the plurality of BBUs offered by a second group of different vendors.

In various embodiments, the step of maintaining performance data further comprises maintaining the performance data by the processing system arranged at a cell site. The step of generating the target combination further comprises generating the target combination with the processing system arranged in the cell site. The method 270 further includes accessing a RAN hub including a pool of the plurality of BBUs, where the plurality of BBUs includes one or more purpose built BBUs, one or more BBU virtual machines, or a combination thereof.

FIG. 2H depicts an illustrative embodiment of a method 280 in accordance with various aspects described herein. The method 280 includes maintaining, by a processing system including a processor, performance data relating to performance of a plurality of different combinations from a pool of radio units (RUs) and a pool of baseband units (BBUs), wherein the RUs and the BBUs are connected via an open fronthaul interface of the ORAN (Step 281), determining, by the processing system, service and performance requirements of a user equipment (UE) (Step 283), and based on the performance data and the determined service and performance requirements of the UE, generating, by the processing system, a target combination by mixing and matching the RUs and the BBUs from the pool of RUs and the pool of BBUs such that the target combination facilitates the determined service and performance requirements (Step 285).

In various embodiments, the method 280 includes selecting, by the processing system, the RU and the BBU based on multiple parameters. The multiple parameters comprise performance of the target combination, a compatibility between the selected RU and BBU, an available coverage of the target combination, overall energy consumption and energy savings, or a combination thereof. The method 280 includes, upon checking the multiple parameters, determining, by the processing system, the RU and the BBU to be are offered by different vendors, respectively, in addition to the determined service and performance requirements and the performance data.

In various embodiments, the step of determining service and performance requirements of the UE further comprises determining that the service and performance requirements of the UE require both the RU and the BBU provided by a same vendor. The method 280 further includes accessing, by the processing system, a RAN hub including a pool of the plurality of BBUs. The plurality of BBUs includes one or more purpose built BBUs, BBU virtual machines, or a combination thereof. The method 280 further includes maintaining, by the processing system residing in a service management and orchestration (SMO) platform of the ORAN, a first set of data relating to a pool of RUs offered by a first group of different vendors, and maintaining, by the processing system residing in the SMO platform of the ORAN, a second set of data relating to a pool of BBUs offered by a second group of different vendors. The processing system arranged in the SMO platform of the ORAN is communicatively connected to the plurality of RUs via the plurality of BBUs.

While for purposes of simplicity of explanation, the respective processes are shown and described as a series of blocks in FIGS. 2E through 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the embodiments described above, the adaptive multi-vendor RAN BBU and RU selection systems and methods implement and facilitate a platform to mix and match a multi-vendor RAN BBU and RU to optimize performance. Selection of the multi-Vendor RAN BBU and RU can be implemented at a local RAN system or at a centralized SMO platform operating in the ORAN. The selection of the different RAN (purposed built BBUs or virtual machines in the cloud RAN) and RUs are based on various different parameters or criteria, such as performance of different combinations of the BBU and radio, key features/functions support among different combinations of the BBU and radio, service and performance requirements from different devices and customers, available coverage among different combinations for a given user/customers, overall energy consumption and energy savings, by way of example.

As described above, the adaptive multi-vendor RAN BBU and RU selection systems and methods can be implemented at the local RAN system or at the centralized SMO or both. The SMO which manages the BBUs (either classical BBUs or BBUs in the cloud RAN) and RUs from all RAN vendors. The adaptive multi-vendor RAN BBU and RU selection systems and methods can be used for both the RAN baseband (e.g. cloud RAN or purpose built baseband) all at the cell sites (e.g., the distributed RAN) or the RAN baseband placed at the centralized hub with pooling (e.g., the centralized RAN).

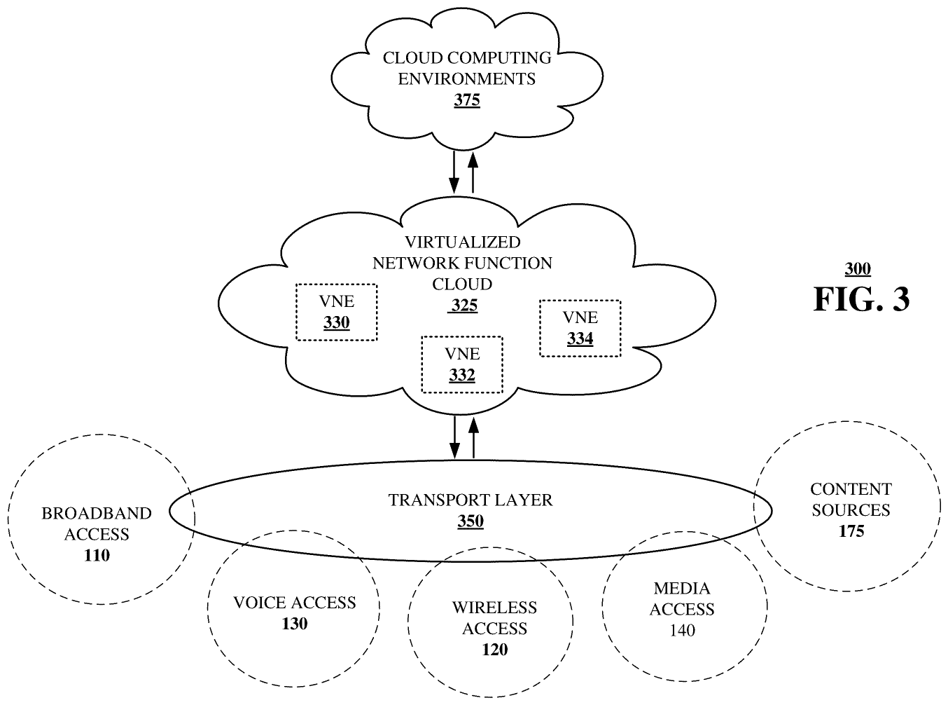

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200 and 240 and methods 250, 260, 270 and 280 presented in FIGS. 1, 2B, 2D, 2E through 2H, and 3. For example, virtualized communication network 300 can facilitate in whole or in part systems and methods for mixing and matching multi-vendor baseband units and radio units in open radio access networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

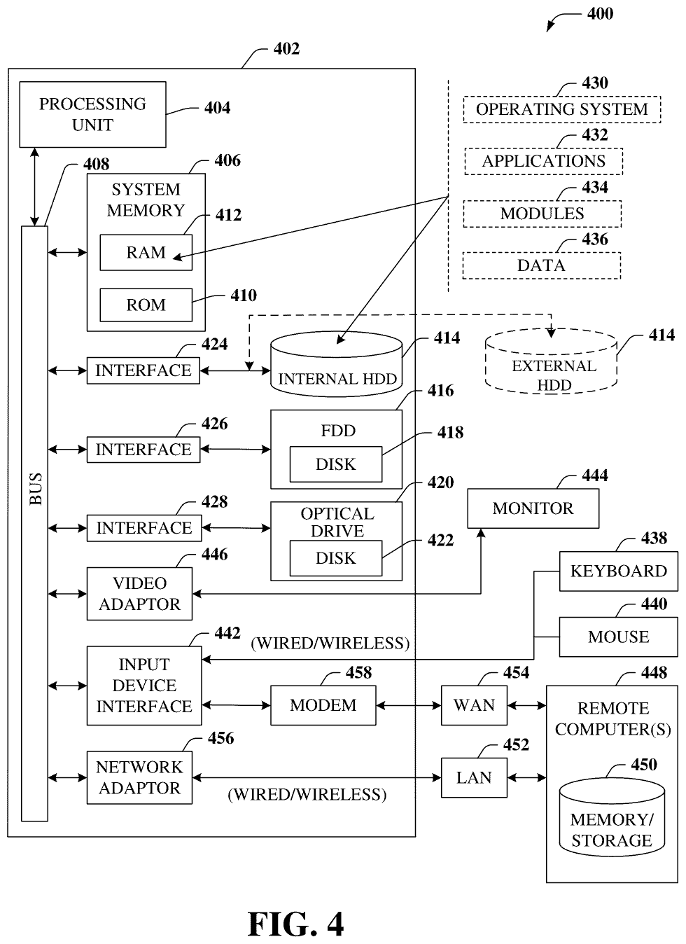

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for mixing and matching multi-vendor baseband units and radio units in open radio access networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

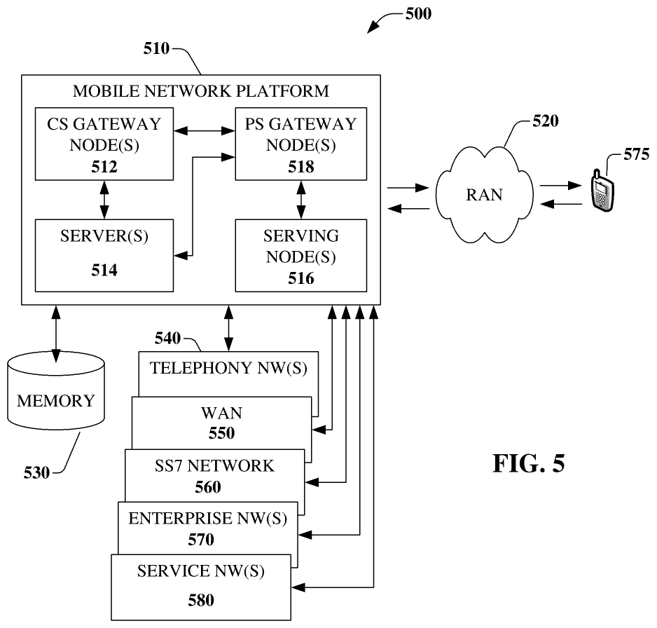

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods for mixing and matching multi-vendor baseband units and radio units in open radio access networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

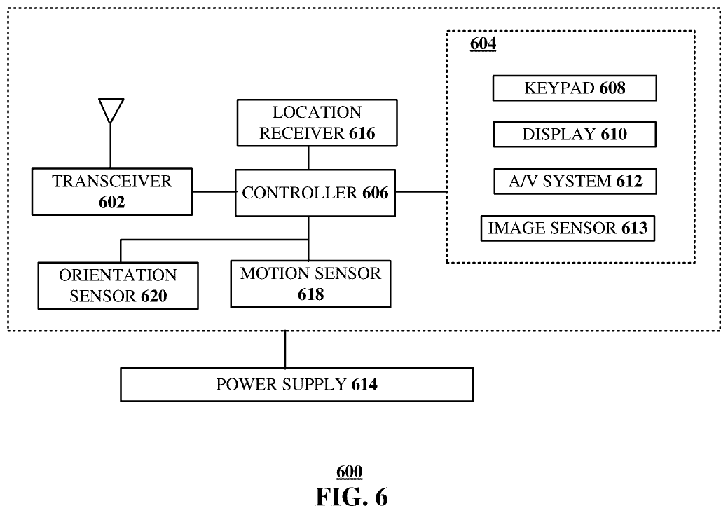

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods for mixing and matching multi-vendor baseband units and radio units in open radio access networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
storing a first set of data relating to a pool of radio units (RUs) offered by a first group of vendors;
storing a second set of data relating to a pool of baseband units (BBUs) offered by a second group of vendors, wherein the RUs and the BBUs are connected via an open fronthaul interface of Open Radio Access Network (ORAN);
maintaining a third set of data relating to performance of a plurality of different combinations between each RU in the pool of RUs and each BBU in the pool of BBUs; and
at least based on the third set of data, selecting a RU among the pool of RUs and a BBU among the pool of BBUs and generating a target combination.

2. The device of claim 1, wherein one or more BBUs among the pool of BBUs are arranged at a respective cell site.

3. The device of claim 1, wherein a part of BBUs or all BBUs in the pool of BBUs are arranged at a RAN hub.

4. The device of claim 1, wherein the pool of BBUs are arranged at a cloud RAN as one or more virtual machines.

5. The device of claim 1, wherein the selecting the RU among the pool of RUs and the BBU among the pool of BBUs further comprises selecting the RU and the BBU based on multiple parameters, wherein the multiple parameters comprise performance of the target combination, a compatibility between the selected RU and BBU, an available coverage of the target combination, overall energy consumption and energy savings, or a combination thereof.

6. The device of claim 1, wherein the operations further comprise determining service and performance requirements of a user equipment (UE).

7. The device of claim 6, wherein the generating the target combination further comprises, based on the determined service and performance requirements of the UE, generating the target combination that meets the determined service and performance requirements of the UE.

8. A non-transitory machine-readable medium, comprising executable instructions that, when executed by a processing system including a processor, facilitate performance of operations, the operations comprising:
maintaining performance data relating to performance of a plurality of different combinations between a plurality of radio units (RUs) and a plurality of baseband units (BBUs), wherein the plurality of RUs and the plurality of BBUs are connected via an open fronthaul interface of Open Radio Access Network (ORAN);
determining service and performance requirements of a user equipment (UE); and
based on the performance data and the determined service and performance requirements of the UE, generating a target combination by selecting a RU among the plurality of RUs and selecting a BBU among the plurality of BBUs, wherein the target combination meets the determined service and performance requirements.

9. The non-transitory machine-readable medium of claim 8, wherein the operations further comprise:
determining to use the target combination offered by a same vendor by selecting the RU and the BBU offered by the same vendor in light of the determined service and performance requirements of the UE.

10. The non-transitory machine-readable medium of claim 8, wherein the generating the target combination further comprise generating the target combination by selecting the RU and the BBU offered by different vendors.

11. The non-transitory machine-readable medium of claim 8, wherein:
the maintaining performance data further comprises maintaining the performance data by the processing system arranged in a service maintenance and orchestration (SMO) platform of the ORAN; and
the generating the target combination further comprises generating the target combination with the processing system arranged in the SMO platform, and
wherein the processing system arranged in the SMO platform is communicatively connected to the plurality of RUs via the plurality of BBUs.

12. The non-transitory machine-readable medium of claim 8, wherein:
the maintaining performance data further comprises maintaining the performance data by the processing system arranged at a cell site; and
the generating the target combination further comprises generating the target combination with the processing system arranged in the cell site.

13. The non-transitory machine-readable medium of claim 8, wherein the operations further comprise accessing a RAN hub including a pool of the plurality of BBUs, wherein the plurality of BBUs includes one or more purpose built BBU, one or more BBU virtual machine, or a combination thereof.

14. A method, comprising:
maintaining, by a processing system including a processor, performance data relating to performance of a plurality of different combinations from a pool of radio units (RUS) and a pool of baseband units (BBUs), wherein the RUs and the BBUs are connected via an open fronthaul interface of Open Radio Access Network (ORAN);
determining, by the processing system, service and performance requirements of a user equipment (UE); and
based on the performance data and the determined service and performance requirements of the UE, generating, by the processing system, a target combination by mixing and matching the RUs and the BBUs from the pool of RUs and the pool of BBUs such that the target combination facilitates the determined service and performance requirements.

15. The method of claim 14, comprising:
selecting, by the processing system, the RU and the BBU offered by a same vendor in light of the determined service and performance requirements.

16. The method of claim 14, comprising:
selecting, by the processing system, the RU and the BBU based on multiple parameters, wherein the multiple parameters comprise performance of the target combination, a compatibility between the selected RU and BBU, an available coverage of the target combination, overall energy consumption and energy savings, or a combination thereof.

17. The method of claim 16, comprising:
upon checking the multiple parameters, determining, by the processing system, the RU and the BBU to be are offered by different vendors respectively in addition to the determined service and performance requirements and the performance data.

18. The method of claim 14, wherein the determining service and performance requirements of the UE further comprises determining that the service and performance requirements of the UE require both the RU and the BBU provided by a same vendor.

19. The method of claim 14, further comprising:
accessing, by the processing system, a RAN hub including the pool of BBUs, wherein the BBUs includes one or more purpose built BBUs, one or more BBU virtual machines, or a combination thereof.

20. The method of claim 14, further comprising:
maintaining, by the processing system residing in a service management and orchestration (SMO) platform of the ORAN, a first set of data relating to a pool of RUs offered by a first group of different vendors; and
maintaining, by the processing system residing in the SMO platform of the ORAN, a second set of data relating to a pool of BBUs offered by a second group of different vendors,
wherein the processing system arranged in the SMO platform of the ORAN is communicatively connected to the plurality of RUs via the BBUs.
